(19) United States
(12) Patent Application Publication
(10) Pub. No.: US 2008/0220137 A1
(43) Pub. Date: Sep. 11, 2008

(54) Skewer holder

(76) Inventors: Eric J. Wangler, Orchard Park, NY (US); Ben O. Scruggs, Prairie Village, KS (US)

Correspondence Address: LAW OFFICE OF JOHN C. MCMAHON, P.O. BOX 30069, KANSAS CITY, MO, 64112, US

(21) Appl. No.: 11/811,728

(22) Filed: Jun. 12, 2007

Related U.S. Application Data
(60) Provisional application No. 60/904,932, filed on Mar. 5, 2007.

(51) Int. Cl. A47J 37/04; A23L 1/01

(52) U.S. Cl. 426/523; 99/421 H

(57) ABSTRACT

A holder for shish kabob skewers having a body and a plurality of bores in one side thereof sized and shaped to simultaneously receive at least two spaced skewers. Each holder also having a knob for grasping and rotating the holder. Preferably, a heat shield at least partially surrounds the grasping knob. The bores being have separate regions adapted to receive skewers of different sizes. The holders being constructed of a low heat retention material, especially silicone to facilitate direct pick up from a grill by a user.

### CROSS REFERENCE TO RELATED APPLICATIONS

This application claims the benefit of U.S. Provisional Application No. 60/904,932 filed Mar. 5, 2007.

### BACKGROUND OF THE INVENTION

The present invention is directed to a holder for skewers of the type used in preparing shish kabob and related food's on a grill.

The term shish kabob generally refers to both a method and a food type wherein meats and/or vegetables are skewered in side by side fashion on a relatively thin skewer and then placed on a barbeque grill or the like for cooking. There are some other related food preparation techniques that use skewers in a similar manner.

An inherent problem with preparing shish kabob is that the food is seldom skewered through the center of gravity of each piece, such that on one side of the skewer each piece of food is usually heavier than the other side. The food is also often slippery or becomes that way during cooking. Consequently, when the skewer is rotated to cook the food on an opposite side, the food often partially or totally rotates on the skewer, so that additional tools or utensils such as tongs or spatulas must be used to try to rotate the food and this often works poorly.

Furthermore, the skewers are frequently constructed of strips of bamboo with sharpened ends. When used on a grill, bamboo skewers of this type tend to burn at the ends and can become very hot. A user can therefore become burned by the skewer in trying to rotate or reposition the food or remove the food from the grill if the user touches the ends with their skin. While metal skewers are available and do not burn, such have relatively high heat capacity and store substantial heat so that they can also burn a user who tries to pick up the skewer by the ends with the user's fingers and are more expensive than the bamboo.

While prior art has attempted to resolve some of the problems for example by placing the skewers in a rack or by having expensive holders with sliding removal apparatus, such devices are comparatively expensive and do not function with simple bamboo skewers and the like. Because grocery stores are now preparing shish kabob and do not want to include expensive skewers with the food that would substantially increase the cost of the product, it is desirable to find a system that functions well with conventional bamboo skewers, but can use other types of skewers also.

Therefore, a device was found to be needed that would function with simple conventional skewers, would prevent the food from rotating relative to the skewers and which would allow a user to pick up the skewers by hand while on the grill for rotation or removal without the user becoming burnt. Finally, it is preferred that such a device also control multiple skewers so that skewers could be used in pairs and that multiple skewers can be handled by the same device.

### SUMMARY OF THE INVENTION

A handle for preferably holding a plurality of skewers, especially in multiple skewer pairs. The handle is also preferably used in pairs so as to be positioned at opposite ends of the skewers.

Each handle includes a body with a series of parallel and spaced bores on one side thereof. The bores have a progressively narrowing or step down diameter, so as to allow the bores to snugly receive skewers of different diameter. The bores are positioned to hold pairs of skewers wherein each skewer of a pair passes through the same food items in parallel but spaced relationship to each other to prevent rotation of the food about a single skewer.

The handle also has a central axis parallel to the bores and a turning knob that extends coaxially with the axis and opposite the skewer openings for the bores. The knob is comparatively thin and includes axial aligned outer ridges to help a user grip the knob.

The entire handle is preferably constructed of a low heat capacity material and especially a US Federal Drug Administration approved silicone having a durometer shore A value of from 70-80 and a degradation temperature of about 506° Fahrenheit. Each handle transfers little heat to a user upon touching and thereby allows a user to both rotate the food and remove it form the grill by grasping the handle. The knob facilitates rotation of the food while at the grill. Ribs are provided on grasping knobs for the handles to reduce the surface area of the handle device that directly touches the user, thereby reducing heat transfer. Each handle preferably holds two skewers, such that food is loaded onto both skewers at the same time, so as to more easily maintain a parallel orientation of the skewers and skewered region of the food.

In certain embodiments a shield is provided to divert heat from the grasping knob. The shield can be hemispherical in shape or partially hemispherical to allow for easier grasping.

The handles allow a user to turn, rotate, flip or remove the food from the grill or other heating surface by allowing contact of limited duration without burning or overheating the skin of the user.

### OBJECTS AND ADVANTAGES OF THE INVENTION

Therefore, the objects of the present invention are: to provide a holder for use in conjunction with skewers on a grill or other cooking surface that have low heat capacity and allow a user to pick up the holder from the grill by hand without the holder burning the user; to provide such handles that are constructed of silicone; to provide such a holder used in pairs to receive opposite ends of skewers; to provide such a holder having a plurality of bores with each bore being parallel to other and adapted to receive a single skewer such that pairs of skewers can be inserted though a single group of food pieces and then joined at apposite ends to such handles; to provide such handles having bores that are tapered so as to be adapted to receive skewers of different diameters; to provide such a handle having a turning knob extending coaxially relative to the handle and from an opposite side of the handle that receives the skewers; to provide a handle that incorporates a shield to deflect heat from the grasping knob so as to make it cooler to the touch when removing the kabob from the grill; to provide such a handle that can be adapted to receive multiple pairs of skewers; and to provide such handles that are comparatively easy and inexpensive to make and that are especially will suited for the intended use thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is perspective view of a double skewered shish kabob with handles at each end thereof according to the present invention and illustrating the positioning of the shish kabob on a grill and a user's hands rotating the shish kabob using knobs on the holders.

FIG. 2 is an enlarged and fragmentary side elevational view showing the shish kabob on a grill with one handle.

FIG. 3 is a top plan view of the handle.

FIG. 4 is a front view of the handle.

FIG. 5 is a cross-sectional view of the handle, taken along line 5-5 of FIG. 4.

FIG. 6 is a rear view of the handle.

FIG. 7 is a cross-sectional view of the handle similar to FIG. 5 demonstrating the ability of the handle to receive skewers of different diameters.

FIG. 8 is a perspective view of a modified handle according to the present inventions.

FIG. 9 is a front elevational view of the modified handle.

FIG. 10 is a top plan view of the modified handles.

FIG. 11 is a side view of the modified handle.

FIG. 12 is a cross-sectional view of the modified handle, taken along line 12-12 of FIG. 11, showing two pairs of skewers about to be inserted into the handle.

FIG. 13 is a bottom plan view of a second modified handle in accordance with the invention.

FIG. 14 is a side elevational view of the second modified handle.

FIG. 15 is a bottom plan view of a third modified handle in accordance with the invention.

FIG. 16 is a side elevational view of the third modified handle.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

A pair of holders or handles 1 are provided for receiving multiple skewers 2 for cooking shish kabob 4 on a grill 5. The handles 1 are manipulated by fingers 7 of a user's hands 8.

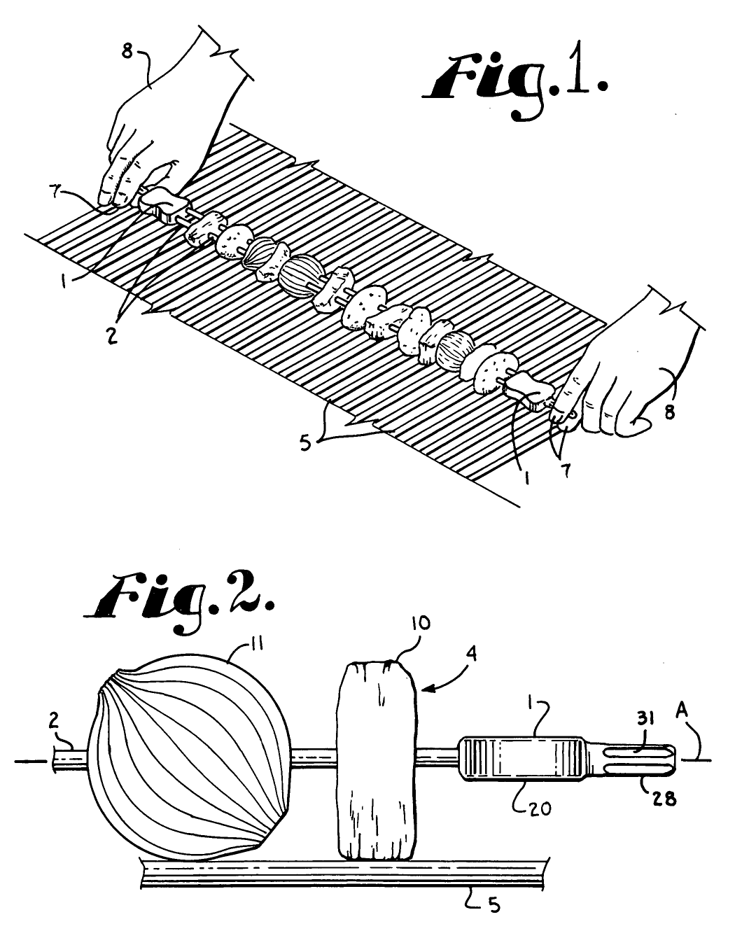

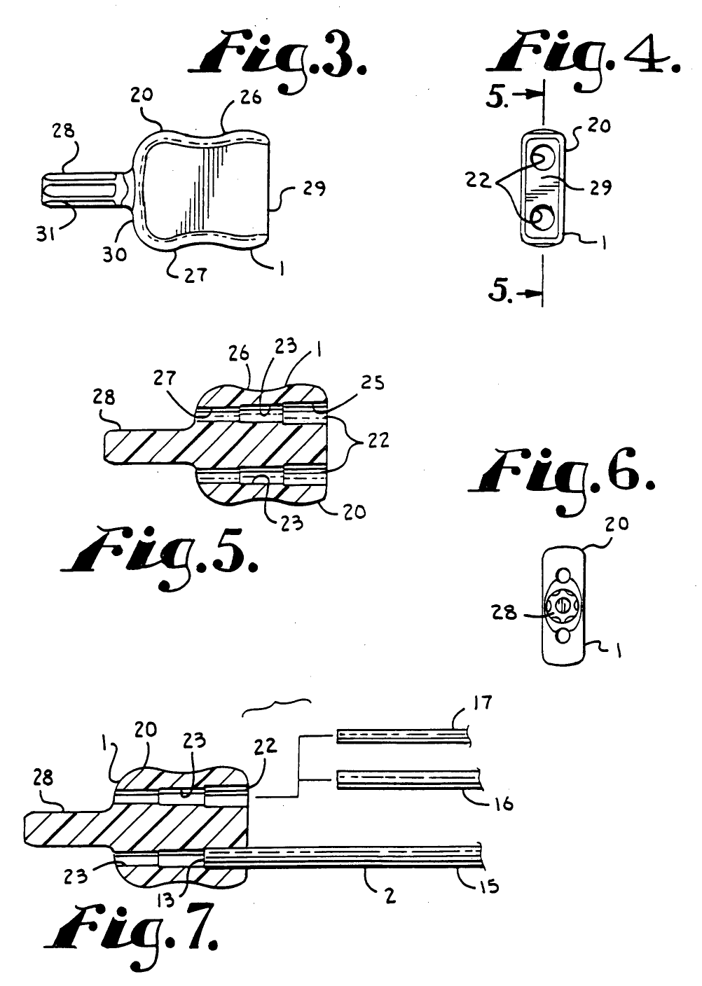

As shown in FIGS. 1 and 2, a pair of skewers 2 of the type constructed of bamboo, metal or other suitable material are inserted through various food items such as meat pieces 10 and/or vegetable pieces 11 of the shish kabob 4. The skewers 2 are parallel to one another and may have pointed or flat ends 13. The skewers 2 have a specific diameter and skewers in general having standard size diameters may be used in accordance with the invention. For example, FIG. 7 shows skewers 15, 16 and 17 of different diameter.

Each handle 1 has a body 20 that is generally rectangular, as seen in FIG. 3, with the sides 26 and 27 pinched inwardly slightly. Each handle 1 is wider than thick and is sized and shaped to be spaced from the grill 5 during use by the food pieces 10 and 11, as is seen in FIG. 2.

Located at a front side 29 of each handle 1 are a pair of spaced openings 22 from which parallel and spaced bores 23 extend into the body 20. Each bore 23 has first, second and third regions 25, 26 and 27 of decreasing diameter and each region 25, 26 and 27 is sized and shaped to snugly a respective skewer 15, 16 and 17.

Located on the rear side 30 of the body 20 opposite the openings 22 is a knob 28. The knob 28 is generally cylindrical and has an axis of rotation A that is coaxial with the axis of rotation of the body 20. The knob 28 is sized and shaped to be grasped by a user's fingers 7, as seen in FIG. 1 and rotated. The knob 28 has a series of ribs 31 to facilitate grasping. The ribs 31 provide discontinuous engagement of the knob 28 with the skin of the user, as compared to the entire radial outer surface of the knob 28, so that there is reduced heat transfer to the fingers of the user than if the user grasped the knob 28 without the ribs 31.

Each holder 1 is constructed of a low heat capacity and retention material, preferably a silicone. The material of construction is especially a silicone that does not experience heat degradation below about 506° Fahrenheit and has a durometer of Shore A about between 70 and 80.

In use pairs of skewers 2 are inserted through food pieces or chunks 10 and 11 in spaced but parallel relationship to each other. Skewer ends 13 are inserted in respective bores 23 in opposite handles 1 and pushed until snugly seated by friction or restriction with the bores 23 forming a shish kabob assembly 35. Most skewers 2 are of the type having a sharp end and a dull or unsharpened end. Normally, the skewers are first both loaded into one handle 1 by the unsharpened end. This way food can be loaded onto the sharpened ends simultaneously and with proper spacing. The shish kabob 4 assembly 35 is then placed on the grill 5. When one side of the shish kabob 4 is cooked, the user or cooker grasps the knobs 28 using the user's fingers 7 and rotates the shish kabob 4 to a second side thereof. When fully cooked, the user again grasps the knobs 28 of opposite handles 1 and takes the shish kabob 4 from the grill 5. The bores 23 preferably pass entirely through each holder 1 to allow for easier cleaning and sanitation.

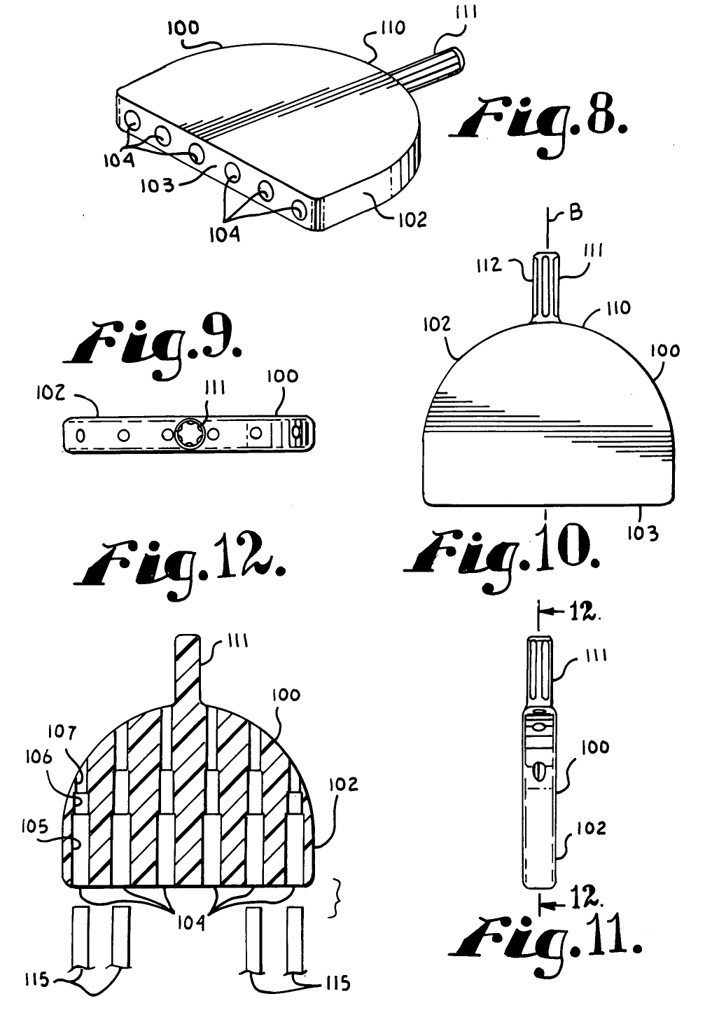

A modified handle 100 is shown in FIGS. 8 through 12. The handle 100 is similar in many ways to handle 1 and only portions that are different are discussed here.

The handle 100 has a body 102 that is generally semicircular when viewed from the top, as seen in FIG. 10, with a height that is substantially less than the width thereof.

Extending inwardly from a body front side 103 are six parallel and spaced bores 104. The bores 104 each have step down regions 105, 106 and 107 similar to handle 1. Extending from a body rear side 110 opposited side 103 is a turning knob 111. The knob 111 is generally cylindrical with axial extending and grip improving ribs 112. The knob 111 is coaxial along Axis B with the body. Two fragmentary pairs of skewers 115 are shown in FIG. 12 just prior to insertion into the far left and right pairs of bores 104. In this manner two different arrangements of shish kabob can be cooked on the pairs of skewers 115 in side by side relationship.

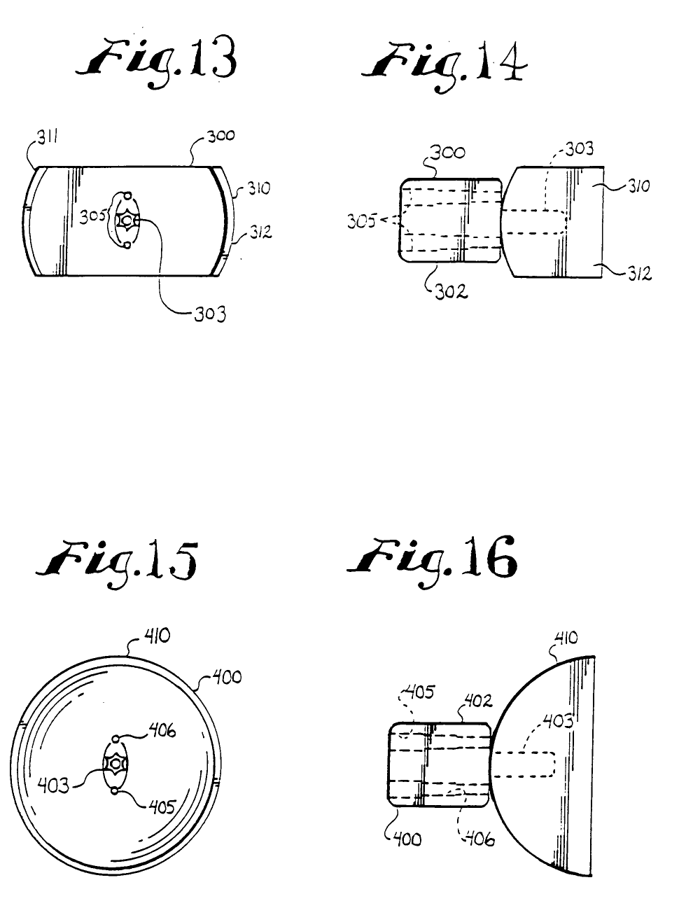

Illustrated in FIGS. 12 and 13 is a skewer handle generally identified by the reference numeral 300. The handle 300 has certain elements and structure in common with the handle 1 and reference is made to the description of the handle 1 for additional detail.

The handle 300 includes a generally rectangular body 302 with a rearward projecting grasping knob 303 and a pair of front to rear pass through skewer receiving bores 305 and 306.

Projecting rearward from the body 302 and about the knob 303 is a shield 310. The shield 310 has a truncated hemispherical shape wherein side portions of a hemisphere are removed. The shield 310 is relatively thin and surrounds the knob 303, but is spaced sufficiently far to allow finger access to the knob 303. Shield top and bottom portions 311 and 312 are aligned to be located between the fire and the knob 303 during use, whether the handle 300 is bottom side down or top side down when the skewers are turned over. The open spaces on the sides between the top and bottom portions 311 and 312 allow finger access to the knob 303. It is foreseen that this shield could be parabolic or U-shaped in cross section or a thin semi cylindrical shell.

Illustrated in FIGS. 14 and 15 is a skewer handle generally identified by the reference numeral 400. The handle 400 has certain structure detail in common with the handle 1 and reference is made to the description of the handle 1 for additional detail.

The handle 400 includes a body 402 with a rearward projecting grasping knob 403 and a pair of skewer receiving bores 405 and 406.

The handle 400 includes a shield 410 that extends rearward from the body 402 so as to generally surround the knob 403 except to the rear. The shield 410 is in the form of a thin hemispherical shell that is centrally secured to the body 402 at the frontward end of the grasping knob 403. The shield 410 is sufficiently spaced from the rearward end of the knob 403 to allow a user to insert fingers between the knob 403 and shield 410 to grasp the knob 403. The shield 410 deflects at least some heat that would otherwise transfer by radiation to the knob 403 during cooking, thereby making the knob 403 more comfortable to pick up by the user.

While the devices of the present application are especially useful in conjunction with shish kabob as described, it is foreseen that such may be used for cooking other similar or similarly cooked foods on a grill or other heated surface.

As used herein the terms handle and holder are understood to especially mean structure that allows a user a place to grasp to manipulate cooking food, such as shish kabob and to flip, turn or rotate the food on the cooking surface or to quickly place the food, after cooking, on a plate, tray or other carrier. While a user may hold the device for a longer time, normally the contact between the handle or holder and the skin of the user would be short.

It is to be understood that while certain forms of the present invention have been illustrated and described herein, it is not to be limited to the specific forms or arrangement of parts described and shown.

What is claimed and desired to be secured by Letters Patent is as follows:

1. A handle adapted to receive skewers of the type used for shish kabob comprising:
a) a body having a plurality of spaced and parallel bores opening on a fist side thereof;
b) each of said bores being sized and shaped to snugly receive a skewer.

2. The handle according to claim 1 wherein:
a) said body has an axis of rotation parallel to said bores; and including
b) a knob extending outward from said handle opposite the side whereat the bores begin and being coaxial with said axis.

3. The handle according to claim 2 including:
a) a shield partially surrounding the knob and spaced from the knob sufficiently to allow finger access to the knob.

4. The handle according to claim 3 wherein:
a) said shield is a hemispherical shell.

5. The handle according to claim 3 wherein:
a) said shield is a partial hemispherical shell with opposed ends truncated.

6. The handle according to claim 2 wherein:
a) said knob is generally cylindrical in shape and has gripping ribs thereon that extend radially outward.

7. The handle according to claim 1 wherein:
a) each of said bores has a first region of a first diameter sized and shaped to snugly receive a first skewer of a first size; and
b) each bore subsequently has at least one region of a second and smaller diameter to alternatively and snugly receive a second skewer of a second size.

8. The handle according to claim 1 wherein:
a) said handle is constructed of silicone.

9. The handle according to claim 8 wherein:
a) said silicone has a Shore A durometer of between about 70 and 80.

10. The handle according to claim 1 wherein:
a) said handle has at least two pairs of bores positioned to receive two paired sets of skewers wherein each skewer pair passes parallel through common food pieces.

11. A method of cooking shish kabob including the steps of:
a) placing various food items on a first skewer;
b) placing a second skewer through said food items parallel to, and spaced from said first skewer;
c) placing opposite ends of each skewer in bores in respective handles wherein each handle has a bore for receiving an end of a respective skewer;
d) placing the skewered shish kabob on a grill for cooking;
e) thereafter turning the shish kabob; and
f) then removing the shish kabob from the grill after being fully cooked.

12. The method according to claim 11 including the step of:
a) providing each of said handles with a turning knob parallel to said skewers; and
b) utilizing said knob to turn the shish kabob.

13. The method accord to claim 11 including the step of:
a) providing said holders that are constructed of silicone; and
b) picking said handles up from the grill directly by said handles.

14. In a skewer holder having a body that operably receives skewers for cooking on a grill, the improvement including:
a) a grasping knob extending rearward of the body; and
b) a shield spaced from and extending about said grasping knob.
